(19) United States
(12) Patent Application Publication
(10) Pub. No.: US 2026/0161274 A1
(43) Pub. Date: Jun. 11, 2026

(54) USER INTERFACE FOR ADJUSTING IMAGE EFFECTS DEPICTED IN IMAGES

(71) Applicant: Adobe Inc., San Jose, CA (US)

(72) Inventors: Thomas Knoll, Malibu, CA (US); Eric Kee, Pittsburgh, PA (US); Adam Pikielny, Issaquah, WA (US)

(21) Appl. No.: 18/975,655

(22) Filed: Dec. 10, 2024

(51) Int. Cl. G06F 3/04845; G06F 3/04847; H04N 5/262

(52) U.S. Cl. CPC G06F 3/04845; G06F 3/04847; H04N 5/262

(57) ABSTRACT

Disclosed embodiments may provide techniques for adjusting image effects using an image-effect control interface. A method includes providing an image-effect control interface for adjusting an image effect (e.g., a reflection effect, a flare effect) depicted in an input image. The image-effect control interface includes: (i) an effect-range user-interface element that displays a range of the image effect to be applied to the input image; and (ii) a control user-interface element configured to adjust an intensity of the image effect of the input image. The method can also include detecting user interactions that moves the control user-interface element in different directions away from the initial position and reaching updated positions of the effect-range user-interface element. The method can also include reducing or enhancing the image effect from the input image according to the updated positions of the control user-interface element.

The present disclosure relates generally to a user interface for adjusting image effects depicted in images. In one example, the systems and methods described herein may be used to modify image pixels using a blending algorithm to enhance or reduce image effects depicted in images.

### BACKGROUND

Image effects can alter a visual appearance of a given image. For example, image effects include reflections that depict certain objects to faintly appear in the image as if they are being reflected from a mirrored surface. Other effects include a flare effect or a shadow effect. The image effects can be intentionally added to create aesthetically pleasing effects or emulate lens imperfections for realistic depiction of objects. Although the image effects can enhance visual appeal of the image, they can also be unintentionally introduced to the image to result in addition of distracting artifacts or diminishment of the image's overall quality.

### SUMMARY

Disclosed embodiments may provide a user interface for adjusting image effects depicted in images. In some implementations, an image-effect control interface includes: (i) an effect-range user-interface element to display a range of image effects to be applied to an input image; and (ii) a control user-interface element for adjusting the intensity of the image effect within the range specified by the effect-range user-interface element. The control user-interface element can be moved in different directions to incrementally reduce or enhance the image effect, in which the reduction or enhancement of the image effect can be performed using blending algorithms.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 shows an example screenshot of a user interface for adjusting image effects depicted in images, according to some embodiments.

FIG. 2 illustrates an example schematic diagram for adjusting image effects depicted in an image, according to some embodiments.

FIG. 3 shows an example computing environment for adjusting image effects depicted in images, according to some embodiments.

FIG. 4 shows an illustrative example of a process for adjusting image effects depicted in images, according to some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Existing techniques provide processes for removing certain image effects from a given image. For example, the existing techniques extract reflection effects from a digital image. However, existing techniques involve completely removing the image effect and do not provide an intuitive way for users to control or customize the degree of image-effect removal. This often results in limited flexibility and user dissatisfaction with content-editing applications. In addition, existing techniques fall short of properly blending of images. For example, sensor saturation and clipping can cause non-linearity and generate inaccurate results when blending two different images. Accordingly, the lack of an intuitive interface and precise blending lead to unrealistic image effects during the image-effect adjustments. These challenges collectively make it difficult for the user to achieve a seamless, accurate, and user-friendly image-effect adjustments using the existing techniques.

To address these above-noted deficiencies, the present techniques provide an image-effect control interface that facilitates adjusting an image effect depicted in different images. A content-editing application causes an input image and the image-effect control interface to be displayed on a graphical-user interface. As an illustrative example, the image includes a reflection of a user who had captured the input image using a camera device.

The image-effect control interface includes an effect-range user-interface element that displays a range of the image effect to be applied to the input image. The image-effect control interface also includes a control user-interface element configured to adjust an intensity of the image effect of the input image. Continuing with the example, the image-effect control interface includes a slider (e.g., the effect-range user-interface element) and an arrow icon (e.g., the control user-interface element) within the slider user interface. In some instances, the control user-interface element is located at an initial position of the effect-range user-interface element. Continuing with the example, the initial position of the control user-interface element can be located in the middle of the effect-range user-interface element.

The content-editing application detects a first user interaction that moves the control user-interface element in a first direction away from the initial position and reaching a first updated position of the effect-range user-interface element. For example, the first user interaction moves the control user-interface element in a right direction away from its initial middle position. Continuing with the example, the control user-interface element moves to the first updated position indicating an adjustment parameter of “+80”, in which the adjustment parameter indicates that the reflection is to be reduced by 80%.

The content-editing application reduces the image effect from the input image according to the first updated position of the control user-interface element. Continuing with the example, the content-editing application reduces the reflection from the input image by 80%, if the first updated position indicates the adjustment parameter of “+80.” As a result, the reflection of the user in the image is reduced and the other image objects are more clearly defined.

The content-editing application detects a second user interaction that moves the control user-interface element in a second direction away from the initial position and reaching a second updated position of the effect-range user-interface element. The second direction is opposite from the first direction. For example, the second user interaction moves the control user-interface element in a left direction away from its initial middle position. Continuing with the example, the control user-interface element moves to the second updated position indicating an adjustment parameter of “−20”, in which the adjustment parameter indicates that the reflection is to be enhanced by 20%.

The content-editing application enhances the image effect from the input image according to the second updated position of the control user-interface element. Continuing with the example, the content-editing application enhances the image effect from the input image by 20%, if the second updated position indicates the adjustment parameter of “−20.” As a result, the reflection of the user in the image is increased such the other image objects are further obscured in the image.

The present techniques thus provide a significant improvement over existing content-editing tools by providing a user interface that can enhance or reduce the image effects in a granular manner. The image-effect control interface includes intuitive user-interface elements that facilitate users adjust the intensity of image effects in an image. For example, a three-point slider interface offers a range of image-effect control, starting with the original image at its midpoint. By moving a control element to a first direction of the slider, a user can reduce the image effect (e.g., reflection) from the image. Conversely, shifting the control element in the opposite direction increasing reveals only the image-effect components. The bidirectional nature of the image-effect control interface allows users to incrementally enhance or reduce the image effects without the need for additional or confusing UI elements, thereby improving the efficiency and effectiveness of content-editing applications.

### I. Techniques for Adjusting Image Effects Depicted in Images

As described herein, the present techniques are directed to a user interface that allows the user to move an image-effect control interface to control the intensity of the image effect (e.g., a reflection effect) being added or removed from the image. For example, when the slider is set to 0, the original image is shown. When set to +100, an effect-excluded image can be shown. When set between 0 and 100, the original image and the effect-excluded image are blended to depict a partially reduced image effect. Conversely, the opposite slider direction towards −100 can be used to incrementally enhance the image effect from the original image. As a result, the present techniques allow the user to adjust the intensity of the image effects to obtain an image having the desired image effects.

### A. Example Implementation

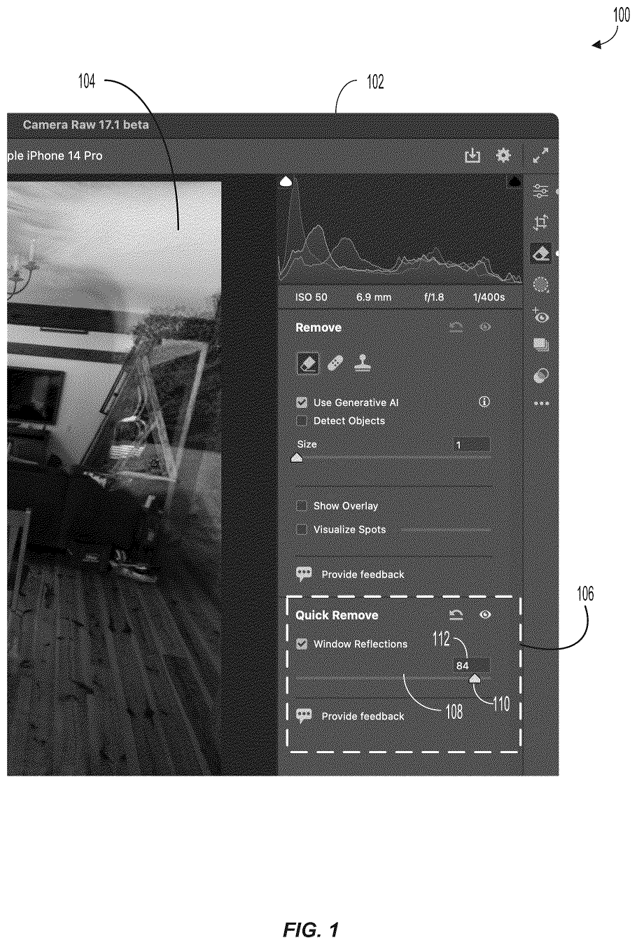

FIG. 1 shows an example screenshot 100 of a user interface for adjusting image effects depicted in images, according to some embodiments. As shown in FIG. 1, the user interface 102 displays an image 104 and an image-effect control interface 106. The image 104 shows a visual representation of a room with different types of objects. In addition, the image 104 shows a reflection effect, which the undesirable image artifacts appear to be intensely reflected on the image 104. The image-effect control interface 106 is implemented to enhance or reduce the reflection effect such that the user obtains an output image with the desired reflection effect.

The image-effect control interface 106 includes an effect-range user-interface element 108 that displays a range of the image effect to be applied to the image 104. As shown in FIG. 1, the effect-range user-interface element 108 is a slider. The image-effect control interface 106 additionally displays a control user-interface element 110 configured to adjust the intensity of the reflection effect of the image 104. Continuing with the example, the control user-interface element 110 corresponds to an arrow icon positioned within the slider interface. In some instances, the control user-interface element 110 is located at a particular position of the effect-range user-interface element 108. A number element 112 shows an adjustment parameter associated with the particular position of the control user-interface element 110. Continuing with the example, the number element 112 shows the adjustment parameter of “84”.

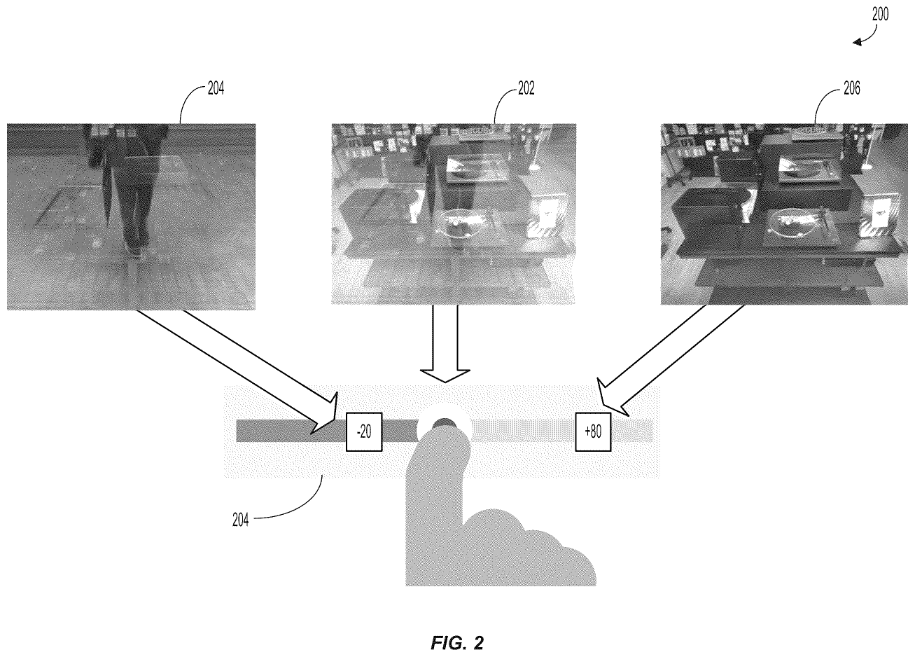

The content-editing application is configured to detect user interactions that moves the control user-interface element in different directions within the effect-range user-interface element, which causes the image effect to be adjusted within an image. FIG. 2 illustrates an example schematic diagram 200 for adjusting image effects depicted in an image 202, according to some embodiments. For example, the user interactions can indicate moving the control user-interface element in a right direction away from its initial middle position within the image-effect control interface 204 and reaching an updated position. Based on the updated position of the control user-interface element, the content-editing application determines an amount of image-effect reduction or enhancement to be applied to the input image. For example, the control user-interface element moves to the updated position indicating an adjustment parameter of “+80”, in which the adjustment parameter indicates that the image effect is to be reduced by 80%. As a result, the reflection effect is adjusted to show an effect-reduced image 206. If the control user-interface element moves at an opposite direction to reach a different position indicating an adjustment parameter of “−20”, the image effect is thereby enhanced by 20% to show an effect-enhanced image 208. Accordingly, the user interactions can be performed to refine the adjustments to the image effect depicted in the image 202.

### B. Computing Environment

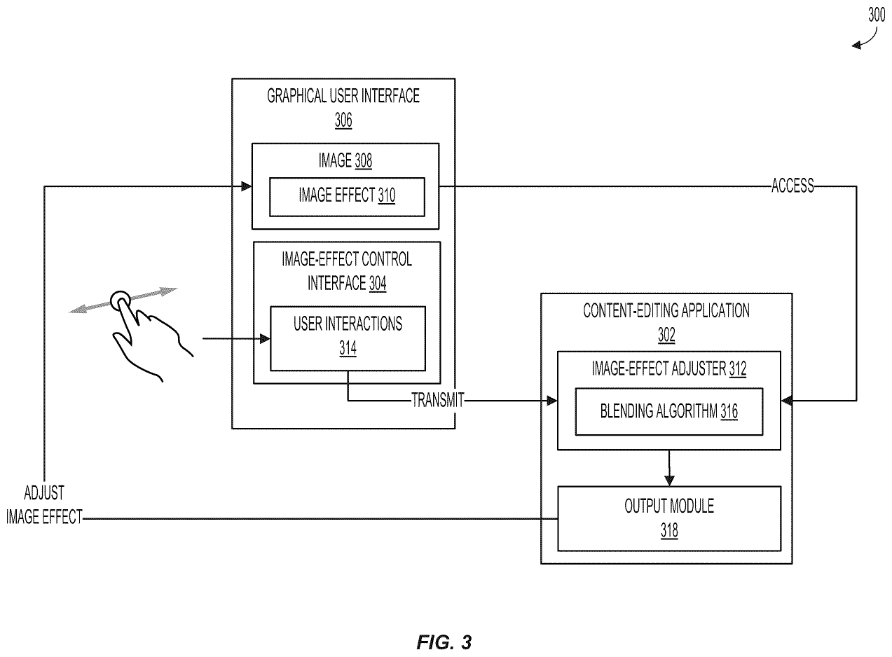

FIG. 3 shows an example computing environment 300 for adjusting image effect 310 depicted in images, according to some embodiments. A content-editing application 302 provides an image-effect control interface 304 on a graphical user interface 306. The image-effect control interface 304 is configured to adjust an intensity of an image effect 310 depicted in an input image 308. The input image 308 includes a visual representation of a scene or an object captured by a camera device (e.g., a smartphone camera, video recorder). The input image 308 includes a matrix of pixels, in which each pixel identifies color (e.g., RGB values) and intensity information. The input image 308 can be a video frame of a plurality of video frames. In some instances, the input image 308 is a raw digital image. Additionally or alternatively, the input image 308 can be encoded in file formats such as JPEG, PNG, or TIFF. The input image 308 can also be associated with metadata that identifies additional information about how or when the image was captured.

In some instances, the image effect 310 includes a reflection effect, a shadow effect, and/or a flare effect. For example, the reflection effect includes one or more image artifacts that appear to be reflected from a glossy or reflective surface (e.g., water, glass) depicted in the input image 308. In another example, the flare effect includes one or more image artifacts characterized by bright, radiating streaks or bursts of light that obscure portions of the input image 308.

The image-effect control interface 304 includes an effect-range user-interface element that displays a range of the image effect 310 to be applied to the input image 308. For example, the effect-range user-interface element corresponds to a slider user interface. Other examples include a dial or knob interface, a rotational wheel interface, a manual-input interface, and a voice interface. Additionally or alternatively, the effect-range user-interface element includes a stepper interface which allows the user to input + or − buttons to adjust the adjustment parameters associated with the image effect. The image-effect control interface 304 also includes a control user-interface element configured to adjust the intensity image effect 310 of the input image 308. Continuing with the example, the control user-interface element corresponds to a movable icon within the slider interface. In some instances, the control user-interface element is located at an initial position of the effect-range user-interface element. Continuing with the example, the initial position of the control user-interface element can be located in the middle of the effect-range user-interface element.

An image-effect adjustor 312 of the content-editing application 302 detects user interactions 314 that moves the control user-interface element in different directions away from the initial position. For example, the user interactions 314 can indicate moving the control user-interface element in a right direction away from its initial middle position. In another example, the user interactions 314 can indicate moving the control user-interface element in a left direction. Other examples of user interactions for moving the control user-interface element away from the initial position include moving the element up and down, diagonally left and right, clockwise and counterclockwise, and pinch and expand.

Based on the updated position of the control user-interface element, the image-effect adjustor 312 determines an adjustment parameter associated with the updated position. In some instances, the adjustment parameter identifies an amount of image-effect reduction or enhancement to be applied to the input image 308. For example, the control user-interface element moves to the updated position indicating an adjustment parameter of “+80”, in which the adjustment parameter indicates that the image effect 310 is to be reduced by 80%. In another example, the control user-interface element moves at an opposite direction to reach another position indicating an adjustment parameter of “−20”, in which the adjustment parameter indicates that the image effect 310 is to be enhanced by 20%.

Based on the user interactions 314, the image-effect adjustor 312 adjusts the image effect 310 according to the updated position of the control user-interface element. Continuing with the example, the image-effect adjustor 312 reduces the image effect 310 from the input image 308 by 80%, if the updated position indicates the adjustment parameter of “+80.” To adjust the intensity of the image effect 310, the image-effect adjustor 312 generates an effect-excluded image and an effect-isolated image of the input image 308. In some instances, the image-effect adjustor 312 generates the effect-excluded image and the effect-isolated image by applying an effect-isolating machine-learning model to the input image 308. In some instances, the effect-excluded image and the effect-isolated image are raw digital images generated based on raw image data associated with the input image 308. Example machine-learning techniques for generating the effect-excluded image and the effect-isolated image are further described in U.S. patent application Ser. No. 18/426,758 entitled “Removing Image Overlays”, the entire disclosure of which is hereby incorporated into reference in its entirety and for all purposes.

In some instances, the image-effect adjustor 312 selects the effect-excluded image or the effect-isolated image based on a location of the updated position relative to the initial position. For example, the image-effect adjustor 312 selects the effect-excluded image based on the updated position being on the right direction of the initial position. The image-effect adjustor 312 then applies a blending algorithm 316 to the input image 308, the selected effect-adjusted image (e.g., the effect-excluded image), and the adjustment parameter to generate an effect-reduced or an effect-enhanced image. The image effect 310 of the effect-reduced image is reduced or enhanced based on the adjustment parameter.

In some instances, the image-effect adjustor 312 applies the blending algorithm 316 by converting pixels of the input image 308 and pixels of the effect-excluded image from an initial color space into a white-balance recovered space. The blending algorithm 316 then merges pixel data of the input image 308 and the effect-excluded image to generate the effect-reduced image. In some instances, the blending algorithm 316 assigns weights to pixel values of each image based on their position, transparency, or a defined blending region. For example, in linear blending, pixels near the edge of one image may gradually fade into the corresponding pixels of the other, using a weighted average to calculate the final color for each pixel in the overlapping area. In some instances, the weights are determined based on the adjustment parameter. Once the blending is completed, the content-editing application 302 reverts the pixels of the input image 308 and the effect-excluded image back to the initial color space.

The blending algorithm 316 is configured to allow the image-effect control interface 304 to adjust the intensity of image effects dynamically. The blending algorithm 316 processes raw image data (e.g., the effect-excluded image), but performs preprocessing to handle nonlinearities such as sensor saturation and white balancing to generate accurate blending results. As an illustrative example, the blending algorithm 316 uses linear interpolation for blending two images to adjust reflection, which can be expressed by the following formula:

$${I}_{blended} = β {I}_{transmission} + ( 1 - β ) {I}_{original} β ∈ [ 0 , 1 ] \qquad ( 1 )$$

$${I}_{blended} = \vert β \vert {I}_{reflection} + ( 1 - \vert β \vert ) {I}_{original} β ∈ [ - 1 , 0 ] \qquad ( 2 )$$

$$β = f ( α ) \qquad ( 3 )$$

As shown in the above formulas (1)-(3), I_{blended} is the output image (e.g., the effect-reduced image), a is a user-controlled parameter (e.g., ranging from −1 to 1 in the three-point slider interface). Iₜᵣₐₙₛₘᵢₛₛᵢₒₙ is the effect-excluded image, I_{original} is the input image 308, and I_{reflection} is the effect-isolated image associated with the input image 308. In addition, β=0 corresponds to the adjustment parameter of the original image 308, β=+1 represents the adjustment parameter of the effect-excluded image (e.g., no reflections), and β=−1 corresponds to the adjustment parameter of the effect-isolated image.

In some implementations, the blending algorithm 316 initially transforms the α parameter to a new value (e.g., β) to facilitate the slider easier to control based on the α parameter while using the β value for the actual blending parameter. For example, formula (3) provides β can be determined based on applying a mathematical function f(⋅) to the α parameter.

As an illustrative example, the blending algorithm 316 uses f(⋅) to stretch the α parameter towards 0 so that α in [0.75, 1] corresponds to β values in the range of [0.25, 1]. This is because the reflection will often rapidly disappear between alpha [0.75, 1], and so the user needs more fine control there. The same approach may apply to the negative range of the slider interface. The numbers are used for illustrative purposes, and a person skilled in the art can use different types of functions to derive β values to perform blending of two images.

As previously described, before this linear blending is applied, the raw images are transformed into from an original color space ((e.g., camera sensor space, XYZ space, linear sRGB space, linear ProPhoto space) to another color space to address the nonlinearity caused by sensor saturation. Raw images often exhibit a nonlinear response to light, particularly at high intensities in which certain color channels may “clip.” This nonlinearity is corrected by transforming the images (e.g., the image 308, the effect-excluded image) into a white-balanced recovered color space. The preprocessing includes applying an inverse transformation to unclip pixel values near saturation points of the raw digital images, in which the input includes a corresponding camera sensor's characteristics. For instance, if the raw sensor data is R_{raw}, the corrected data R_{corrected} as be determined as follows:

$${R}_{corrected} = \frac{{R}_{raw}}{k} + c \qquad ( 4 )$$

As shown in formula (4), k is a scaling factor, and c is a constant determined by the highlight recovery model. Once the raw digital images are in the white-balanced color recovered space, the blending algorithm 316 can be applied using the linear interpolation formula, as shown in formulas (1)-(3). After blending, the processed image is transformed back into the original color space (e.g., camera sensor space, XYZ space, linear sRGB space, linear ProPhoto space) for display by the graphical user interface 306. The inverse transformation can be used to maintain consistency with the original image format and ensuring that the blending results appear natural and accurate.

Additionally or alternatively, the image-effect adjustor 312 enhances or reduces the image effect 310 by applying a machine-learning model to the adjustment parameter and the input image 308 to generate the effect-adjusted image having its image effect 310 enhance or reduced according to the amount of image-effect reduction. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

Once the effect-adjusted image is generated, an output module 318 of the content-editing application 302 provides the effect-adjusted image to be displayed on the graphical user interface 306. In some instances, the user can save the changes corresponding to the effect-adjusted image or perform additional interactions to adjust intensity of the image effect 310 depicted in the effect-adjusted image. Additionally or alternatively, the user can revert the changes to the effect-adjusted image, and iterate through the effect-adjustment process to adjust the intensity of the image effect 310 until a target image effect 310 is reached.

### C. Methods

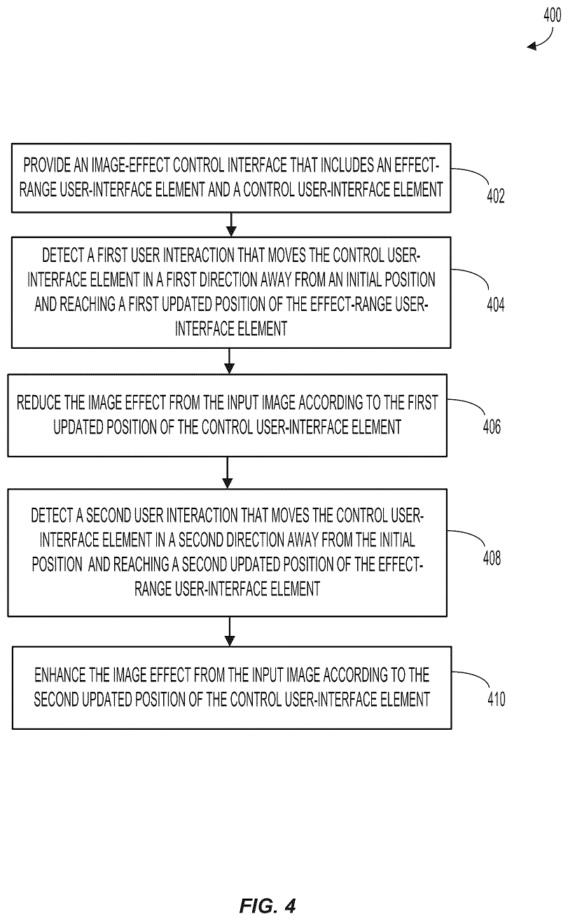

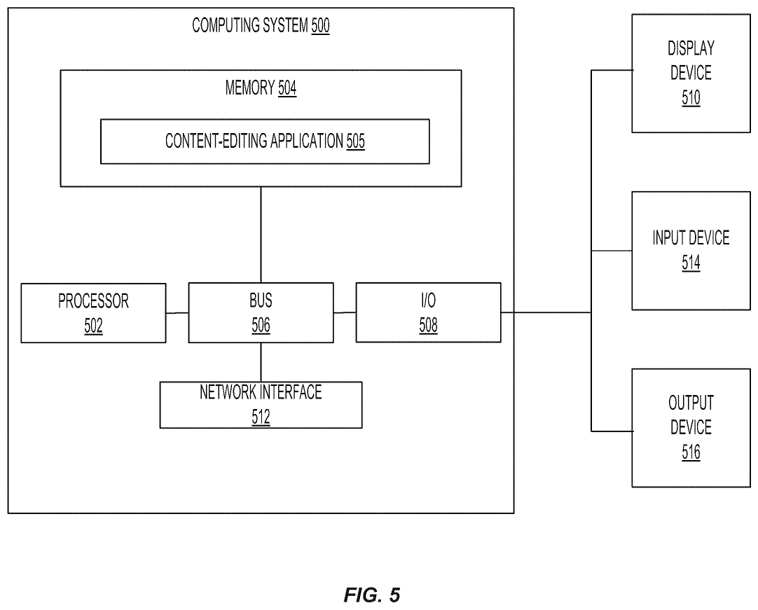

FIG. 4 shows an illustrative example of a process 400 for adjusting image effects depicted in images, according to some embodiments. For illustrative purposes, the process 400 is described with reference to the components illustrated in FIG. 3, though other implementations are possible. For example, the program code for the content-editing application 302 of FIG. 3, is executed by one or more processing devices to cause a server system (e.g., the computing device 502 of FIG. 5) to perform one or more operations described herein.

At step 402, the content-editing application provides an image-effect control interface for adjusting an image effect depicted in an input image. The input image includes a visual representation of a scene or an object captured by a camera device (e.g., a smartphone camera, video recorder). The input image includes a matrix of pixels, in which each pixel identifies color (e.g., RGB values) and intensity information. The input image can be a video frame of a plurality of video frames. In some instances, the input image is a raw digital image. Additionally or alternatively, the input image can be encoded in file formats such as JPEG, PNG, or TIFF. The input image can also be associated with metadata that identifies additional information about how or when the image was captured.

In some instances, the image effect includes a reflection effect, a shadow effect, and/or a flare effect. For example, the reflection effect includes one or more image artifacts that appear to be reflected from a glossy or reflective surface (e.g., water, glass) depicted in the input image. In another example, the flare effect includes one or more image artifacts characterized by bright, radiating streaks or bursts of light that obscure portions of the input image.

The image-effect control interface includes an effect-range user-interface element that displays a range of the image effect to be applied to the input image. For example, the effect-range user-interface element corresponds to a slider user interface. Other examples include a dial or knob interface, a rotational wheel interface, a manual-input interface, and a voice interface. Additionally or alternatively, the effect-range user-interface element includes a stepper interface which allows the user to input + or − buttons to adjust the adjustment parameters associated with the image effect. The image-effect control interface also includes a control user-interface element configured to adjust an intensity of the image effect of the input image. Continuing with the example, the control user-interface element corresponds to a movable icon within the slider interface. In some instances, the control user-interface element is located at an initial position of the effect-range user-interface element. Continuing with the example, the initial position of the control user-interface element can be located in the middle of the effect-range user-interface element.

At step 404, the content-editing application detects a first user interaction that moves the control user-interface element in a first direction away from the initial position and reaching a first updated position of the effect-range user-interface element. For example, the first user interaction moves the control user-interface element in a right direction away from its initial middle position. In some instances, the content-editing application determines an adjustment parameter associated with the first updated position, in which the adjustment parameter identifies an amount of image-effect reduction to be applied to the input image. Continuing with the example, the control user-interface element moves to the first updated position indicating an adjustment parameter of “+80”, in which the adjustment parameter indicates that the image effect is to be reduced by 80%.

At step 406, the content-editing application reduces the image effect from the input image according to the first updated position of the control user-interface element. Continuing with the example, the content-editing application reduces the image effect from the input image by 80%, if the first updated position indicates the adjustment parameter of “+80.”

In some instances, the content-editing application reduces the image effect by initially accessing the adjustment parameter. The content-editing application generates an effect-excluded image by removing the image effect from the input image. The content-editing application then applies a blending algorithm to the input image, the effect-excluded image, and the adjustment parameter to generate an effect-reduced image. The image effect of the effect-reduced image is reduced according to the amount of image-effect reduction. In some instances, the effect-excluded image is a raw digital image generated based on raw image data associated with the input image.

In some instances, the content-editing application applies the blending algorithm by converting pixels of the input image and pixels of the effect-excluded image from an initial color space into a white-balance recovered space. The blending algorithm then merges pixel data of the input image and the effect-excluded image to generate the effect-reduced image. In some instances, the blending algorithm assigns weights to pixel values of each image based on their position, transparency, or a defined blending region. For example, in linear blending, pixels near the edge of one image may gradually fade into the corresponding pixels of the other, using a weighted average to calculate the final color for each pixel in the overlapping area. In some instances, the weights are determined based on the adjustment parameter. Once the blending is completed, the content-editing application reverts the pixels of the input image and the effect-excluded image back to the initial color space.

Additionally or alternatively, the content-editing application reduces the image effect by applying a machine-learning model to the adjustment parameter and the input image to generate the effect-reduced image having its image effect reduced according to the amount of image-effect reduction. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

At step 408, the content-editing application detects a second user interaction that moves the control user-interface element in a second direction away from the initial position and reaching a second updated position of the effect-range user-interface element. The second direction is opposite from the first direction. For example, the second user interaction moves the control user-interface element in a left direction away from its initial middle position. In some instances, the content-editing application determines an adjustment parameter associated with the second updated position, in which the adjustment parameter identifies an amount of image-effect enhancement to be applied to the input image. Continuing with the example, the control user-interface element moves to the second updated position indicating an adjustment parameter of “−20”, in which the adjustment parameter indicates that the image effect (e.g., the reflection effect) is to be enhanced by 20%.

At step 410, the content-editing application enhances the image effect from the input image according to the second updated position of the control user-interface element. Continuing with the example, the content-editing application enhances the image effect from the input image by 20%, if the second updated position indicates the adjustment parameter of “−20.”

In some instances, the content-editing application enhances the image effect by initially accessing the adjustment parameter of the second updated position (e.g., “−20”). The content-editing application generates an effect-isolated image that retains the image effect and excludes one or more remaining portions of the input image. The content-editing application applies a blending algorithm to the input image, the effect-isolated image, and the adjustment parameter to generate an effect-enhanced image. The image effect of the effect-enhanced image is enhanced according to the amount of image-effect enhancement. In some instances, the effect-isolated image is also a raw digital image generated based on the raw image data associated with the input image. Similar to the effect-reduction, the content-editing application applies the blending algorithm by converting pixels of the input image and pixels of the effect-isolated image from the initial color space into the white-balance recovered space.

Additionally or alternatively, the content-editing application enhances the image effect by applying the machine-learning model to the other adjustment parameter and the input image to generate the effect-enhanced image having its image effect reduced according to the amount of image-effect reduction. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods. In some instances, the machine-learning model used to enhance the image effect from the input image is the same as the machine-learning model used to reduce the image effect. Alternatively, the machine-learning model for enhancing the image effect is different model from the machine-learning model used to reduce the image effect. Process 400 terminates thereafter.

### II. Example Systems

Any suitable computing system or group of computing systems can be used for performing the operations described herein. For example, FIG. 5 depicts a computing system 500 that can implement any of the computing systems or environments discussed above. In some embodiments, the computing system 500 includes a processing device 502 that executes the content-editing application 505, a memory that stores various data computed or used by the content-editing application 505, an input device 514 (e.g., a mouse, a stylus, a touchpad, a touch-screen, etc.), and an output device 516 that presents output to a user (e.g., a display device that displays graphical content generated by content-editing application 505). For illustrative purposes, FIG. 5 depicts a single computing system on which the content-editing application 505 is executed, and the input device 514 and output device 516 are present. But these applications, datasets, and devices can be stored or included across different computing systems having devices similar to the devices depicted in FIG. 5.

The example of FIG. 5 includes a processing device 502 communicatively coupled to one or more memory devices 504. The processing device 502 executes computer-executable program code stored in a memory device 504, accesses information stored in the memory device 504, or both. Examples of the processing device 502 include a microprocessor, an application-specific integrated circuit (“ASIC”), a field-programmable gate array (“FPGA”), or any other suitable processing device. The processing device 502 can include any number of processing devices, including a single processing device.

The memory device 504 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C#, Visual Basic, Java, Python, Perl, JavaScript, and ActionScript.

The computing system 500 could also include a number of external or internal devices, such as a display device 510, or other input or output devices. For example, the computing system 500 is shown with one or more input/output (“I/O”) interfaces 508. An I/O interface 508 can receive input from input devices or provide output to output devices. One or more buses 506 are also included in the computing system 500. Each bus 506 communicatively couples one or more components of the computing system 500 to each other or to an external component.

The computing system 500 executes program code that configures the processing device 502 to perform one or more of the operations described herein. The program code includes, for example, code implementing the document-processing application 102 or other suitable applications that perform one or more operations described herein. The program code can be resident in the memory device 504 or any suitable computer-readable medium and can be executed by the processing device 502 or any other suitable processor. In some embodiments, all modules in the content-editing application 505 are stored in the memory device 504, as depicted in FIG. 5. In additional or alternative embodiments, one or more of these modules from the content-editing application 505 are stored in different memory devices of different computing systems.

In some embodiments, the computing system 500 also includes a network interface device 512. The network interface device 512 includes any device or group of devices suitable for establishing a wired or wireless data connection to one or more data networks. Non-limiting examples of the network interface device 512 include an Ethernet network adapter, a modem, and/or the like. The computing system 500 is able to communicate with one or more other computing devices (e.g., a computing device that receives inputs for document-processing application 102 or displays outputs of the document-processing application 102) via a data network using the network interface device 512.

An input device 514 can include any device or group of devices suitable for receiving visual, auditory, or other suitable input that controls or affects the operations of the processing device 502. Non-limiting examples of the input device 514 include a touchscreen, stylus, a mouse, a keyboard, a microphone, a separate mobile computing device, etc. An output device 516 can include any device or group of devices suitable for providing visual, auditory, or other suitable sensory output. Non-limiting examples of the output device 516 include a touchscreen, a monitor, a separate mobile computing device, etc.

Although FIG. 5 depicts the input device 514 and the output device 516 as being local to the computing device that executes the document-processing application 102, other implementations are possible. For instance, in some embodiments, one or more of the input device 514 and the output device 516 include a remote client-computing device that communicates with the computing system 500 via the network interface device 512 using one or more data networks described herein.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method comprising:
providing an image-effect control interface for adjusting an image effect depicted in an input image, wherein the image-effect control interface includes:
an effect-range user-interface element that displays a range of the image effect to be applied to the input image; and
a control user-interface element configured to adjust an intensity of the image effect of the input image, wherein the control user-interface element is located at an initial position of the effect-range user-interface element;
detecting a first user interaction that moves the control user-interface element in a first direction away from the initial position and reaching a first updated position of the effect-range user-interface element;
reducing the image effect from the input image according to the first updated position of the control user-interface element;
detecting a second user interaction that moves the control user-interface element in a second direction away from the initial position and reaching a second updated position of the effect-range user-interface element, wherein the second direction is opposite from the first direction; and
enhancing the image effect from the input image according to the second updated position of the control user-interface element.

2. The method of claim 1, wherein the image effect includes a reflection effect, a shadow effect, and/or a flare effect.

3. The method of claim 1, wherein reducing the image effect from the input image includes:
determining an adjustment parameter associated with the first updated position, wherein the adjustment parameter identifies an amount of image-effect reduction to be applied to the input image;
generating an effect-excluded image by removing the image effect from the input image; and
applying a blending algorithm to the input image, the effect-excluded image, and the adjustment parameter to generate an effect-reduced image.

4. The method of claim 3, wherein applying the blending algorithm includes converting pixels of the input image and pixels of the effect-excluded image into a white-balance recovered space.

5. The method of claim 1, wherein enhancing the image effect from the input image includes:
determining an adjustment parameter associated with the second updated position, wherein the adjustment parameter identifies an amount of image-effect enhancement to be applied to the input image;
generating an effect-isolated image that retains the image effect and excludes one or more remaining portions of the input image; and
applying a blending algorithm to the input image, the effect-isolated image, and the adjustment parameter to generate an effect-enhanced image.

6. The method of claim 1, wherein reducing the image effect from the input image includes:
determining an adjustment parameter associated with the first updated position, wherein the adjustment parameter identifies an amount of image-effect reduction to be applied to the input image; and
applying a machine-learning model to the adjustment parameter and the input image to generate an effect-reduced image.

7. The method of claim 1, wherein enhancing the image effect from the input image includes:
determining an adjustment parameter associated with the second updated position, wherein the adjustment parameter identifies an amount of image-effect enhancement to be applied to the input image; and
applying a machine-learning model to the adjustment parameter and the input image to generate an effect-enhanced image.

8. A system comprising:
one or more processors; and
a non-transitory computer-readable medium storing instructions that when executed by the one or more processors, cause the one or more processors to perform operations including:
providing an image-effect control interface for adjusting an image effect depicted in an input image, wherein the image-effect control interface includes:
an effect-range user-interface element that displays a range of the image effect to be applied to the input image; and
a control user-interface element configured to adjust an intensity of the image effect of the input image, wherein the control user-interface element is located at an initial position of the effect-range user-interface element;
detecting a first user interaction that moves the control user-interface element in a first direction away from the initial position and reaching a first updated position of the effect-range user-interface element;
reducing the image effect from the input image according to the first updated position of the control user-interface element;
detecting a second user interaction that moves the control user-interface element in a second direction away from the initial position and reaching a second updated position of the effect-range user-interface element, wherein the second direction is opposite from the first direction; and
enhancing the image effect from the input image according to the second updated position of the control user-interface element.

9. The system of claim 8, wherein the image effect includes a reflection effect, a shadow effect, and/or a flare effect.

10. The system of claim 8, wherein reducing the image effect from the input image includes:
determining an adjustment parameter associated with the first updated position, wherein the adjustment parameter identifies an amount of image-effect reduction to be applied to the input image;
generating an effect-excluded image by removing the image effect from the input image; and
applying a blending algorithm to the input image, the effect-excluded image, and the adjustment parameter to generate an effect-reduced image.

11. The system of claim 8, wherein enhancing the image effect from the input image includes:
determining an adjustment parameter associated with the second updated position, wherein the adjustment parameter identifies an amount of image-effect enhancement to be applied to the input image;
generating an effect-isolated image that retains the image effect and excludes one or more remaining portions of the input image; and
applying a blending algorithm to the input image, the effect-isolated image, and the adjustment parameter to generate an effect-enhanced image.

12. The system of claim 8, wherein reducing the image effect from the input image includes:
determining an adjustment parameter associated with the first updated position, wherein the adjustment parameter identifies an amount of image-effect reduction to be applied to the input image; and
applying a machine-learning model to the adjustment parameter and the input image to generate an effect-reduced image.

13. The system of claim 8, wherein enhancing the image effect from the input image includes:
determining an adjustment parameter associated with the second updated position, wherein the adjustment parameter identifies an amount of image-effect enhancement to be applied to the input image; and
applying a machine-learning model to the adjustment parameter and the input image to generate an effect-enhanced image.

14. A non-transitory computer-readable medium storing instructions that when executed by one or more processors, cause the one or more processors to perform operations including:
providing an image-effect control interface for adjusting an image effect depicted in an input image, wherein the image-effect control interface includes:
an effect-range user-interface element that displays a range of the image effect to be applied to the input image; and
a control user-interface element configured to adjust an intensity of the image effect of the input image, wherein the control user-interface element is located at an initial position of the effect-range user-interface element;
detecting a first user interaction that moves the control user-interface element in a first direction away from the initial position and reaching a first updated position of the effect-range user-interface element;
reducing the image effect from the input image according to the first updated position of the control user-interface element;
detecting a second user interaction that moves the control user-interface element in a second direction away from the initial position and reaching a second updated position of the effect-range user-interface element, wherein the second direction is opposite from the first direction; and
enhancing the image effect from the input image according to the second updated position of the control user-interface element.

15. The non-transitory computer-readable medium of claim 14, wherein the image effect includes a reflection effect, a shadow effect, and/or a flare effect.

16. The non-transitory computer-readable medium of claim 14, wherein reducing the image effect from the input image includes:
determining an adjustment parameter associated with the first updated position, wherein the adjustment parameter identifies an amount of image-effect reduction to be applied to the input image;
generating an effect-excluded image by removing the image effect from the input image; and
applying a blending algorithm to the input image, the effect-excluded image, and the adjustment parameter to generate an effect-reduced image.

17. The non-transitory computer-readable medium of claim 16, wherein applying the blending algorithm includes converting pixels of the input image and pixels of the effect-excluded image into a white-balance recovered space.

18. The non-transitory computer-readable medium of claim 14, wherein enhancing the image effect from the input image includes:
determining an adjustment parameter associated with the second updated position, wherein the adjustment parameter identifies an amount of image-effect enhancement to be applied to the input image;
generating an effect-isolated image that retains the image effect and excludes one or more remaining portions of the input image; and
applying a blending algorithm to the input image, the effect-isolated image, and the adjustment parameter to generate an effect-enhanced image.

19. The non-transitory computer-readable medium of claim 14, wherein reducing the image effect from the input image includes:
determining an adjustment parameter associated with the first updated position, wherein the adjustment parameter identifies an amount of image-effect reduction to be applied to the input image; and
applying a machine-learning model to the adjustment parameter and the input image to generate an effect-reduced image.

20. The non-transitory computer-readable medium of claim 14, wherein enhancing the image effect from the input image includes:
determining an adjustment parameter associated with the second updated position, wherein the adjustment parameter identifies an amount of image-effect enhancement to be applied to the input image; and
applying a machine-learning model to the adjustment parameter and the input image to generate an effect-enhanced image.
